(19) United States
(12) Patent Application Publication
(10) Pub. No.: US 2005/0039401 A1
(43) Pub. Date: Feb. 24, 2005

(54) Apparatus for generating virtually pure hydrogen for fuel cells

(75) Inventors: Arnold Lamm, Elchingen (DE); Thomas Poschmann, Ulm (DE); Jochen Schaefer, Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/910,686

(22) Filed: Aug. 3, 2004

(30) Foreign Application Priority Data
Aug. 12, 2003 (DE) DE 103 37 014.5
Sep. 1, 2003 (DE) DE 103 40 173.3

(51) Int. Cl. B01J 8/00

(52) U.S. Cl. 48/198.7; 48/127.9; 48/128; 48/198.3

(57) ABSTRACT

An apparatus generates virtually pure hydrogen for fuel cells, and includes a device for reforming starting substances having at least one hydrocarbon-containing compound and water. Furthermore, the apparatus has catalytic agents for producing a water gas shift reaction in the reformate gas stream generated by the reforming device. Moreover, the apparatus includes a device for separating hydrogen out of the reformate gas stream using membranes which are selectively permeable to hydrogen. The hydrogen-separating device includes a proportion of the catalytic agents for producing the water gas shift reaction. A device for exchanging thermal energy between the reformate gas stream and a further stream of medium is arranged downstream, as seen in the direction of flow, of the reforming device. The device for exchanging thermal energy includes a further proportion of the catalytic agents for producing the water gas shift reaction.

Priority is claimed to German Patent Application DE 103 37 014.5, filed Aug. 12, 2003, and German Patent Application DE 103 40 173.3, filed Sep. 1, 2003, the entire disclosures of which are incorporated by reference herein.

### BACKGROUND

The present invention relates to an apparatus for generating virtually pure hydrogen for fuel cells.

An apparatus of the generic type is described by Japanese Patent Application 2002068710 A. The apparatus has a reformer and a membrane module with membranes that are selectively permeable to hydrogen. In its entry space for the reformate gas, the membrane module has a catalyst for producing a water gas shift reaction, producing what is known as a membrane reactor.

A membrane reactor of this type offers the option of integrating the water gas shift reaction into the entry space of the membrane module. A similar structure is also described by U.S. Pat. No. 5,525,322.

Now, the drawback of membrane reactors of this type is that the materials which are currently available, such as for example Pd, etc., for the production of the hydrogen-selective membranes, although highly selective under appropriate operating conditions, are relatively expensive. Therefore, the aim must be to use the minimum possible quantity of membrane material. On account of the high selective permeability which can be achieved, however, the overall space available in the reformate-gas-side entry region then becomes so small that the catalyst for producing the water gas shift reaction can no longer be accommodated in sufficient quantities in the membrane reactor.

Moreover, the catalyst may disadvantageously be overheated by the hot reformate flowing out of the reformer. This may both damage the catalyst and interfere with the water gas shift reaction.

In the context of the general prior art, U.S. Pat. No. 5,498,278 also shows a structure of the membranes which is such that the actual selective material is applied as a thin film to a porous support material for mechanical stability.

### SUMMARY OF THE INVENTION

An object of the present invention is to provide an apparatus for generating virtually pure hydrogen for fuel cells which avoids the abovementioned drawbacks and, while taking up a minimal amount of space and entailing the lowest possible costs, makes it possible to provide a large quantity of virtually pure hydrogen per unit volume of the starting substances used.

The present invention thus provides an apparatus for generating virtually pure hydrogen for fuel cells, having:
a device for reforming starting substances which comprise at least one hydrocarbon-containing compound and water;
having catalytic agents for producing a water gas shift reaction in the reformate gas stream generated by the reforming device; and
having a device for separating hydrogen out of the reformate gas stream by means of membranes which are selectively permeable to hydrogen, the hydrogen-separating device including a proportion of the catalytic agents for producing the water gas shift reaction, characterized in that
a device (5) for exchanging thermal energy between the reformate gas stream and a further stream of medium is arranged downstream, as seen in the direction of flow, of the device (4) for reforming starting substances, the device (5) for exchanging thermal energy including a further proportion of the catalytic agents for producing the water gas shift reaction.

The device for exchanging thermal energy between the reformate gas stream and a further stream of medium is arranged downstream, as seen in the direction of flow, of the device for reforming starting substances. This device for exchanging thermal energy is responsible in particular for cooling the reformate gas stream from its very high starting temperatures when it emerges from the reforming device to a temperature which is suitable for operating the device for separating off hydrogen. The temperature level which is typically suitable for operating the hydrogen-separating device is in this context also suitable for operating a water gas shift reaction with the aid of the catalytic agents for producing this reaction.

The thermal energy which is released to the further stream of medium is typically in turn of benefit to the apparatus for generating virtually pure hydrogen, for example by virtue of the further stream of medium preheating, evaporating and/or superheating at least a proportion of the starting substances or by virtue of the further stream of medium being, for example, one of the feed streams for, for example, catalytic combustion, which provides thermal energy for operating the apparatus.

The catalytic means for producing a water gas shift reaction are now partially arranged in the device for separating off hydrogen and partially in the device for exchanging thermal energy. A temperature level which is suitable for the water gas shift reaction prevails both in the hydrogen-separating device and in—at least the exit-side part of—the device for exchanging thermal energy, and consequently with a structure of this nature it is possible to obtain very favorable conditions for the water gas shift reaction.

The apparatus according to the present invention particularly advantageously allows the space for an independent water gas shift stage which is required in conventional structures to be saved. The apparatus according to the invention has two crucial advantages over the use of a pure membrane reactor. The use of the device for exchanging thermal energy creates the possibility of operating the device for reforming the starting substances at a correspondingly high temperature. This results in a high degree of variation in the operation conditions of the device for reforming the starting substances without its exit temperature necessarily having to be suitable for a water gas shift reaction or the permeation of hydrogen in the hydrogen-separating device. This is because the device for exchanging thermal energy, despite the high variability and high temperature, and therefore correspondingly high yields of hydrogen from the region of the reforming device, nevertheless allows a suitable temperature level for the water gas shift reaction, on the one hand, and the permeation of the hydrogen, on the other hand to be obtained.

A further advantage is the division of the catalytic agent required in order to produce a water gas shift reaction between at least a part of the device for exchanging thermal energy and the hydrogen-separating device. Compared to the pure membrane reactor, which includes all the catalytic agent required to produce a water gas shift reaction in the region of the hydrogen-separating device, this gives the advantage that the hydrogen-separating device can be significantly smaller and therefore need only have the surface area of membranes which are selectively permeable to hydrogen that is absolutely imperative in order to produce the desired quantity of hydrogen. Since the materials which are selectively highly permeable to hydrogen, such as for example Pd and/or elements belonging to transition group 5 and alloys thereof are relatively expensive, in addition to the simple saving on space in the hydrogen-separating device, it is at the same time possible also to achieve a significant saving in terms of materials costs.

However, since materials of this type are so highly selective that the catalytic agent for producing a hydrogen gas shift reaction which is available in a hydrogen-separating device of this type which is optimized with regard to costs and installation space, is not sufficient for the corresponding gas quantity, the further proportion of the catalytic agent, which is arranged in the region of the device for exchanging thermal energy, is able to ensure that sufficient quantities of substance are converted by the water gas shift reaction.

Therefore, the apparatus according to the present invention provides a very simple, expedient, efficient and highly compact apparatus for generating virtually pure hydrogen for fuel cells.

The use of the apparatus according to the present invention for generating pure hydrogen from petrol or diesel may be particularly advantageous for the purpose of heating fuel cells (fuel cell stack 2) in a motor vehicle, water-borne or airborne vehicle, in particular as an auxiliary power unit.

The statements which have already been made above have made it clear that the apparatus produced here takes up a minimal amount of overall space with regard to the hydrogen yield which is to be achieved. Therefore, the apparatus according to the invention is particularly suitable for the said use, since in this case too, and in particular for applications as an auxiliary power, unit (APU), the minimal overall size gives rise to significant advantages with regard to the space taken up and also with regard to packaging.

### BRIEF DESCRIPTION OF THE DRAWINGS

The present invention is explained in greater detail in the following on the basis of exemplary embodiments and with reference to the drawings in which:

FIG. 1 shows a diagrammatically depicted fuel cell system.

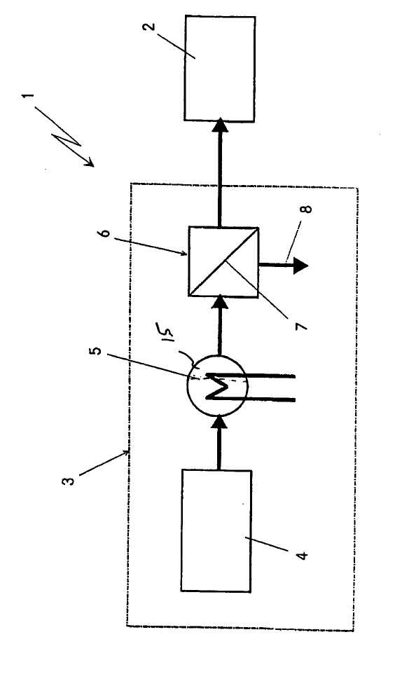

### DETAILED DESCRIPTION

The fuel cell system 1 which is highly diagrammatically depicted in the only appended figure comprises a fuel cell stack 2, in particular based on a plurality of PEM fuel cells. Furthermore, the fuel cell system 1 comprises a highly diagrammatically depicted apparatus 3 for generating virtually pure hydrogen for operating the fuel cell stack 2. The apparatus 3 is subdivided into three main components, once again highly diagrammatically depicted.

The first component is a device 4 for reforming starting substances, which may be designed, for example, as an autothermal reformer or as a steam reformer. According to the exemplary embodiment illustrated here, this reformer 4, starting from a liquid hydrocarbon or hydrocarbon derivative, in particular petrol, diesel or methanol, together with water and if appropriate air as further starting substances, will generate a hydrogen-containing gas. Depending on the type of reforming, this hydrogen-containing reformate gas will leave the device 4 at relatively high temperatures of the order of magnitude of from 500 to 900° C. The reformate gas stream then passes into a device 5 for exchanging thermal energy between the reformate gas stream and a further stream of medium. In the region of this device for exchanging thermal energy, which may be designed, for example, as a plate-type heat exchanger, the further stream of medium gives rise to cooling of the reformate gas stream to a temperature level of approx. 350 to 450° C. The further stream of medium is heated as a result. It can be used for other purposes in the apparatus 3, so that the thermal energy which has been transferred to it from the reformate gas stream can be utilized for the apparatus 3. For this purpose, the further stream of medium may, for example, be a stream of the starting substances for the reforming, which is heated, evaporated and/or superheated in the region of the device 5. However, it is also conceivable for the further stream of medium to be part of a starting material for carrying out afterburning of fuel cell exhaust gases and/or fuel or the like for obtaining or recovering thermal energy. In this context, it is certainly sensible for the further stream of medium to be utilized in the apparatus 3, so that the thermal energy which it contains is not lost overall to the fuel cell system 1. In principle, however, it would also be possible, without the functioning of the apparatus 3 being impaired, for the further stream of medium to be a pure stream of cooling medium, and for the thermal energy which it takes up not to be utilized for the fuel cell system 1.

After it has flowed through the device 5, the reformate gas stream, which has now been cooled, passes into the region of a device 6 for separating hydrogen out of the reformate gas stream using membranes 7 which are selectively permeable to hydrogen. After it has permeated through the membranes 7, the now virtually pure hydrogen passes into the region of the fuel cell stack 2, while the residual gas which remains can be fed for combustion or the like via a line 8 which is only outlined in the figure.

To use the apparatus 3 to produce the maximum possible yield of virtually pure hydrogen—containing impurities, such as for example carbon monoxide, only in the range of a few hundred particles per million hydrogen particles (ppm)—it is suitable for a water gas shift reaction to take place in addition to the pure reforming in the device 4 and the permeation of the hydrogen out of the reformate gas stream in the device 6. A water gas shift reaction of this type is known to produce carbon dioxide and hydrogen from the carbon monoxide and water produced during the reforming.

A water gas shift reaction of this type is typically carried out in the presence of suitable catalytic agents for producing this water gas shift reaction. These catalytic agents may in particular contain the elements Ni, Fe, Cr (preferably as FeCr), Rh, Ru and/or Pt. The possible temperature for a water gas shift reaction, in particular what is known as a “high-temperature shift” is of the order of magnitude of approximately 400° C. and below. Since, moreover, this temperature is eminently suitable for ensuring the permeation of the hydrogen through the membranes 7 with a sufficiently high permeation rate, a proportion of the catalytic agents for producing the water gas shift reaction is now arranged in the region of the device 6, producing what is known as a membrane reactor.

In particular, porous bodies coated with a suitable catalytically active material may be introduced in the region of the reformate gas feed stream between the membranes 7 of the device 6, which are, for example, areal in form and are arranged above one another in the style of a plate-heat exchanger. Then, at least part of the water gas shift reaction will take place in the region of these porous elements, so that further hydrogen is generated directly in the region of the device 6. As is known from the abovementioned documents relating to the prior art, in addition to a pure water gas shift reaction being carried out, a corresponding shift in the reaction equilibrium is obtained on account of the hydrogen permeating through the membranes 7. On account of the associated shift in the reaction equilibrium of the water gas shift reaction, the sequences of the latter are positively assisted, so that the hydrogen yield can be increased.

It is possible, as a particularly suitable structure in accordance with the invention, to provide for the membranes 7 to be constructed in such a manner that, at least on the reformate gas side, they include a porous material, for example a sintered metal and/or a sintered ceramic, in one or more layers, serving as a mechanical support structure for the at least one selectively permeable layer of the membrane 7. In addition to their function as a support material, these porous structures may then simultaneously have a coating comprising the appropriate catalytic agents for producing the water gas shift reaction, so that the ideal symbiosis between water gas shift reactor and hydrogen-separating device 6, i.e. a membrane reactor, can be realized with minimal structural outlay.

On account of the highly selective but also relatively expensive materials which are available nowadays, a device 6 of this type can be made so small that the available surface area of the membranes 7 is no longer sufficient to provide the required quantity of catalytic agents to produce a water gas shift reaction. Therefore, further proportions of the catalytic agents for producing the water gas shift reaction are provided in the region of the device 5 for exchanging thermal energy. At least in the subregion on the exit side with respect to the reformate gas stream, in particular the exit-side third 15 of the device 5, temperatures of 450° C. or below prevail, and these temperatures are suitable for using the corresponding catalytic agent for producing a water gas shift reaction, known as the water gas shift catalyst or shift catalyst. If the device 5 is designed as a plate-type heat exchanger, for example, it is possible for the regions which guide the reformate gas stream, either all of these regions or ideally just the exit-side third thereof, to be coated with a suitable shift catalyst. In this case, some of the water gas shift reaction may already take place in the region of the device 5, so that it is possible to save on shift catalyst and therefore construction space and membrane surface area, in the device 6. Moreover, depending on the design of the apparatus 3, it is also possible for the connecting lines connecting the devices 5 and 6 to be coated with a suitable shift catalyst on their surfaces which are in contact with the reformate gas stream.

All in all, the overall result is a structure which allows a sufficient quantity of shift catalysts to be provided with a minimum overall space and minimal deployment of membrane surface area in the device 6, making it possible to generate relatively large quantities of hydrogen per unit quantity of starting substances used. This hydrogen is virtually pure downstream of the device 6 and can be used directly for operation of the fuel cell stack, for example in deadend operation or by means of an anode loop which is known per se.

A particularly expedient use for the structure of the apparatus 3 which is optimized in terms of space and costs is, for example, in motor vehicles, aircraft or boats, in particular yachts, since weight, space taken up and packaging play crucial roles in this context for a system of this type to be used. It can in principle be used both as a drive device, as part of a drive device (e.g. a hybrid system) or as an auxiliary power unit which is completely independent of the drive, since the apparatus 3 can be matched to the corresponding electric power requirement simply by varying its size. In the case of the above-described structure in the style of plate-type heat exchangers or reactors, dimensional variation of this nature can be affected, for example, by varying the number of plates in the device 5 and the number of membranes in the device 6.

1. An apparatus for generating virtually pure hydrogen for fuel cells comprising:
a reforming device for reforming starting substances having at least one hydrocarbon-containing compound and water, the reforming device producing a reformate gas stream;
catalytic agents for producing a water gas shift reaction in the reformate gas stream;
a hydrogen-separating device for separating hydrogen out of the reformate gas stream using membranes selectively permeable to hydrogen, the hydrogen-separating device being assigned a proportion of the catalytic agents for producing the water gas shift reaction; and
a heat exchange device for exchanging thermal energy between the reformate gas stream and a further stream of medium, the heat exchange device being arranged downstream of the reforming device, the heat exchange device being assigned a further proportion of the catalytic agents for producing the water gas shift reaction.

2. The apparatus as recited in claim 1 wherein the heat exchange device is at least partially coated with the catalytic agent for producing the water gas shift reaction.

3. The apparatus as recited in claim 1 wherein the heat exchange device and the hydrogen-separating device are connected by a reformate gas connection, a still further proportion of the catalytic agents for producing the water gas shift reaction being arranged in a region of the reformate gas connection.

4. The apparatus as recited in claim 1 wherein the heat-exchange device has the further proportion of the catalytic agents for producing the water gas shift reaction assigned to a region predominantly facing an outflow region for the reformate gas.

5. The apparatus as recited in claim 1 wherein the further proportion of catalytic agents is located in an exit third of the heat exchange device.

6. The apparatus as recited in claim 1 wherein the hydrogen-separating device has a plurality of areal membranes selectively permeable to hydrogen, with a porous material coated with the proportion of catalytic agent for producing the water gas shift reaction being arranged, on the reformate gas side, at least partially between the membranes.

7. The apparatus as recited in claim 6 wherein the porous material simultaneously serves as a support material for a layer selectively permeable to hydrogen of one of the membranes.

8. The apparatus as recited in claim 7 wherein the layer selectively permeable to hydrogen at least includes Pd and/or elements from transition group 5, and alloys thereof.

9. The apparatus as recited in claim 1 wherein the catalytic agent for producing a water gas shift reaction includes at least one of the elements Ni, Fe, Cr, Pt, Rh, Ru.

10. A method for operating a fuel cell comprising:
generating hydrogen using the apparatus as recited in claim 1 from petrol or diesel; and
supplying the hydrogen to fuel cells in a motor vehicle, water-borne or airborne vehicle.

11. The method as recited in claim 10 wherein the fuel cell is an auxiliary power unit.

12. An auxiliary power unit for a motor vehicle, water-borne vehicle or airborne vehicle comprising:
a hydrogen generator including:
a reformer for reforming starting substances having at least one hydrocarbon-containing compound and water, the reforming device producing a reformate gas stream;
catalytic agents for producing a water gas shift reaction in the reformate gas stream;
a hydrogen-separator for separating hydrogen out of the reformate gas stream using membranes selectively permeable to hydrogen, the hydrogen-separating device being assigned a proportion of the catalytic agents for producing the water gas shift reaction; and
a heat exchanger for exchanging thermal energy between the reformate gas stream and a further stream of medium, the heat exchange device being arranged downstream of the reforming device, the heat exchange device being assigned a further proportion of the catalytic agents for producing the water gas shift reaction; and
a fuel cell receiving hydrogen from the hydrogen generator.
